(19) United States
(12) Patent Application Publication
(10) Pub. No.: US 2014/0212771 A1
(43) Pub. Date: Jul. 31, 2014

(54) ELECTRODE MATERIAL FOR RECHARGEABLE ELECTRICAL CELLS COMPRISING ACTIVATED CARBON FIBERS

(71) Applicants: Arnd Garsuch, Ludwigshafen (DE); Alexander Panchenko, Ludwigshafen (DE); Doron Aurbach, Bne Brak (IL); Ran Elazari, Rishon-LeZion (IL); Gregory Salitra, Rehovat (IL)

(72) Inventors: Arnd Garsuch, Ludwigshafen (DE); Alexander Panchenko, Ludwigshafen (DE); Doron Aurbach, Bne Brak (IL); Ran Elazari, Rishon-LeZion (IL); Gregory Salitra, Rehovat (IL)

(73) Assignee: BASF SE, Ludwigshafen (DE)

(21) Appl. No.: 14/239,441

(22) PCT Filed: Aug. 14, 2012
(86) PCT No.: PCT/IB12/54144

§ 371 Date: Feb. 18, 2014

(30) Foreign Application Priority Data
Aug. 19, 2011 (EP) 11178132.4

(51) Int. Cl. H01M 4/133; H01M 4/04; H01M 4/1393

(52) U.S. Cl. CPC H01M 4/133; H01M 4/1393; H01M 4/0402
USPC 429/338; 429/231.8; 429/188; 429/337; 429/341; 429/342; 442/179; 427/113

(57) ABSTRACT

The present invention relates to an electrode material for an electrical cell comprising activated carbon fibers as component (A) which have been impregnated with elemental sulfur as component (B). The present invention further relates to rechargeable electrical cells comprising at least one electrode which has been produced from or using the inventive electrode material and to a process for producing said inventive electrode material.

The present invention relates to an electrode material for an electrical cell comprising activated carbon fibers as component (A) which have been impregnated with elemental sulfur as component (B).

The present invention further relates to rechargeable electrical cells comprising at least one electrode which has been produced from or using the inventive electrode material and to a process for producing said inventive electrode material.

Secondary batteries, accumulators or “rechargeable batteries” are just some embodiments by which electrical energy can be stored after generation and used (consumed) as required. Owing to the significantly better power density, there has been a move in recent times from water-based secondary batteries to development of batteries in which charge transport is accomplished by lithium ions.

However, the energy density of conventional lithium ion accumulators which have a carbon anode and a cathode based on metal oxides is limited. New horizons have been opened up by lithium-sulfur cells. In lithium-sulfur cells, sulfur in the sulfur cathode is reduced via polysulfide ions to S²⁻ ions, which are oxidized again when the cell is charged. A lithium/sulfur battery is a very attractive system, since elemental sulfur has almost the highest theoretical capacity and highest theoretical energy density of all known cathodes of 1672 mAh g⁻¹ and 2600 Wh kg⁻¹ respectively. In addition to the high capacity, using of sulfur as a cathode material has the advantages of natural abundance, low cost, and environmental friendliness.

A problem, however, is the solubility of the polysulfides, for example Li2S4 and Li2S6, which are soluble in the solvent and can migrate to the anode. The consequences may include: loss of capacitance and deposition of electrically insulating material on the sulfur particles of the electrode. The migration from cathode to anode can ultimately lead to discharge of the affected cell and to cell death in the battery. This unwanted migration of polysulfide ions is also referred to as “shuttling”, a term which is also used in the context of the present invention.

There are numerous attempts to suppress this shuttling. For example, J. Wang et al. propose adding a reaction product of sulfur and polyacrylonitrile to the cathode; Adv. Funct. Mater. 2003, 13, 487 if. This forms a product which arises by elimination of hydrogen from polyacrylonitrile with simultaneous formation of hydrogen sulfide.

X. Ji and L. F. Nazar, J. Mater. Chem., 20, (2010) p. 9821 describe, that many porous and conductive carbon materials with high surface area and various porous volumes such as mesoporous carbon, active carbon, and carbon nanotubes were developed for hosting sulfur as possible composite cathodes for Li/S system. It is believed that encapsulating the sulfur reduces the diffusion of the polysulfides into the electrolyte solution and establishes more efficient electronic conductivity.

It was thus an object of the present invention to provide an electrode material which is simple to produce and which avoids the disadvantages known from the prior art. It was a further object of the present invention to provide a process by which a corresponding electrode material can be produced.

This object is achieved by an electrode material for an electrical cell comprising

(A) activated carbon fibers which have been impregnated with

(B) elemental sulfur.

Activated carbon fibers may, in the context of the present invention, also be referred to as activated carbon fibers (A). Activated carbon fibers (A) are known as such and they are commercially offered in different forms like yarn, woven fabric (fiber cloth), felt, nonwoven, paper or mat.

In one embodiment of the present invention, activated carbon fibers (A) before impregnation with sulfur are in the form of a woven fabric, felt, nonwoven, paper or mat, in particular a woven fabric

Since these networks of activated carbon fibers hold together without the presence of a binder it is possible to obtain electrode material, which is free of a binder. In the state of the art usually one of the components of an electrode material, which is often a composite material, is a binder, which serves principally for mechanical stabilization of the composite material. In these cases the binder is often selected from organic (co)polymers.

In one embodiment of the present invention, the inventive electrode material is free of a binder.

Within the meaning of the present invention the term “free of a binder” does not exclude the presence of a (co)polymer in the electronic material as such. If the electronic material comprises any (co)polymer then this (co)polymer is not primarily used as binder but has another main function.

The material properties of activated carbon fibres, like pore volume, specific surface area, tensile strength or elongation, vary depending on the origin of the activated carbon fibres, for examples depending on the starting polymer, which is carbonized, and depending on the conditions of the preparation of the activated carbon fibres.

In one embodiment of the present invention, the inventive electrode material comprises activated carbon fibers, which before impregnation with sulfur have a specific surface area of 500 to 4000 m²/g, preferably a specific surface area of 1000 to 3000 m²/g. The specific surface area is determined according to the BET method (ISO 9277; Pure Appl. Chem. 57 (1985) 4, 603-619; Gregg, S. J., Sing, K. S. W.: Adsorption, Surface Area and Porosity. 2nd ed., Academic Press, London, 1982, Chapter 4).

In one embodiment of the present invention, the inventive electrode material comprises activated carbon fibers, which before impregnation with sulfur have a pore volume of 0.2 to 1.5 cm³/g, preferably a pore volume of 0.4 to 1.1 cm³/g, particularly preferably a pore volume of 0.6 to 1.0 cm³/g. The pore volume is determined from the N2 adsorption/desorption isotherms measured at 77 K.

In one embodiment of the present invention, the inventive electrode material comprises activated carbon fibers, which before impregnation with sulfur have a tensile strength of 5 to 50 kg/mm² preferably a tensile strength of 30 to 45 kg/mm²

The activated carbon fibers are usually prepared from polymer fibers by thermal treatment of said polymer fibers. Suitable polymer fibers, which usually comprise beside carbon at least hydrogen and eventually also nitrogen and/or oxygen, are carbonized by thermal treatment for example at a temperature in the range from 500 up to 3000° C. Polymers which can be converted to fibers and textiles or clothes followed by carbonization are for example polyacrylonitrile, novolac resins or rayon, a semi-synthetic polymer based on cellulose. During the carbonization process the original polymer loses hydrogen, nitrogen and/or oxygen and the carbon content of the resulting product increases.

In one embodiment of the present invention, the inventive electrode material comprises activated carbon fibers, which before impregnation with sulfur have a carbon content of at least 90% by weight, preferably in the range from 95 up to 100% by weight.

In one embodiment of the present invention, the inventive electrode material comprises activated carbon fibers, wherein the activated carbon fibers before impregnation with sulfur are produced by thermal treatment of fibers consisting of a crosslinked phenol-formaldehyde resin, said thermal treatment taking place at temperature in the range from 700 up to 2500° C.

Elemental sulfur (B) is known as such and can also be referred to as sulfur for short in the context of the present invention.

Methods of impregnation of activated carbon fibers with sulfur are generally known since activated carbon fibers possess high surface area and high pore volume like any activated carbon in general. For example the activated carbon fibers, specially in form of a fiber cloth, like a woven fabric, can be contacted with solutions of sulfur like sulfur in carbon disulfide or toluene, with melted sulfur or with sulfur vapor in order to impregnate the activated carbon fiber. During the impregnation process sulfur itself or solutions of sulfur are adsorbed by the activated carbon and occupy the pores inside of the activated carbon fibers. While the impregnation of activated carbon fibers with solutions of sulfur can be done at a temperature below the boiling point of the corresponding solvent, which later can also be removed at a temperature below the boiling point of said solvent, the impregnation of activated carbon fibers with liquid sulfur or sulfur vapor is preferably done at a temperature close to or above the melting point of sulfur, for example at a temperature in the range from 100 to 300° C. The impregnation of activated carbon fibers with liquid sulfur or sulfur vapor can in principle be done in an open or a closed system, in vacuum or under pressure.

The present invention further provides a process for producing the above described inventive electrode material for an electrical cell, comprising at least one process step wherein

(A) activated carbon fibers and

(B) elemental sulfur

are heated with one another at a temperature of 100 to 300° C., preferably 130 to 170° C. in a closed vessel.

Activated carbon fibers and sulfur have been described above. In particular preferred embodiments of the activated carbon fibers have been described above.

In one embodiment of the present invention, activated carbon fibers (A) which are heated with sulfur are in the form of a woven fabric, felt, nonwoven, paper or mat, in particular a woven fabric.

The weight ratio between activated carbon fibers and sulfur can be varied in a wide range. In order to avoid the removal of excess sulfur, which can not be adsorbed any more in the pores of the activated carbon fibers, preferably a weight ratio between activated carbon fibers and sulfur is chosen by taking the pore volume of the activated carbon fibers into account.

The sulfur/carbon weight ratio of the inventive electrode material is preferably in the range from 0.01 to 1, particularly preferably in the range from 0.05 to 0.8, in particular in the range from 0.1 to 0.6.

The closed vessel used in the inventive process can be any closed vessel known to a person skilled in the art that preferably resists the applied temperature, the resulting pressure and sulfur. For instance the inventive process can be done in a hermetically sealed stainless steel vessel.

The time of the impregnation is not critical. Sulfur and activated carbon fibers can be heated for example for a time period from 0.1 h to 72 h, preferably from 1 h to 48 h, particularly preferably 2 h to 24 h.

The production of the above described inventive electrode material can be done in a single process step or several process steps. For instance the impregnation can be performed at different temperatures for different time periods under different pressure.

Inventive electrode materials are particularly suitable as or for production of electrodes, especially for production of electrodes of lithium-containing batteries, in particular rechargeable batteries. The present invention provides for the use of inventive electrode materials as or for production of electrodes for rechargeable electrical cells. The present invention further provides rechargeable electrical cells comprising at least one electrode which has been produced from or using at least one inventive electrode material as described above.

In one embodiment of the present invention, the electrode in question is the cathode, which can also be referred to as the sulfur cathode or S cathode. In the context of the present invention, the electrode referred to as the cathode is that which has reducing action on discharge (operation).

In one embodiment of the present invention, inventive electrode material is processed to give electrodes, for example in the form of continuous belts which are processed by a battery manufacturer.

Electrodes produced from inventive electrode material may, for example, have thicknesses in the range from 20 to 3000 μm, preferably 40 to 1000 μm, particularly preferably 50 to 700 μm. They may, for example, have a rod-shaped configuration, or be configured in the form of round, elliptical or square columns or in cuboidal form, or as flat electrodes.

In one embodiment of the present invention, inventive rechargeable electrical cells comprise, as well as inventive electrode material, at least one electrode which comprises metallic zinc, metallic sodium or preferably metallic lithium or a lithium alloy, for example an alloy of lithium with tin, silicon and/or aluminum. The electrode which comprises metallic zinc, metallic sodium or metallic lithium is referred to as anode.

In one embodiment of the present invention, the above described inventive rechargeable electrical cells comprise at least one electrode comprising metallic lithium.

Inventive rechargeable electrochemical cells may comprise, in addition to the anode and cathode, further constituents, for example conductive salt, nonaqueous solvent, separator, output conductor, for example made from a metal or an alloy, and also cable connections and housing.

In one embodiment of the present invention, the above described inventive rechargeable electrical cells comprise a liquid electrolyte comprising a lithium-containing conductive salt.

In one embodiment of the present invention, inventive rechargeable electrical cells comprise, in addition to inventive electrode material and a further electrode, in particular an electrode comprising lithium, at least one nonaqueous solvent which may be liquid or solid at room temperature, preferably liquid at room temperature, and preferably selected from polymers, cyclic or noncyclic ethers, cyclic and noncyclic acetals, cyclic or noncyclic organic carbonates and ionic liquids.

In one embodiment of the present invention, above described inventive rechargeable electrical cells comprise at least one nonaqueous solvent selected from polymers, cyclic or noncyclic ethers, cyclic and noncyclic acetals and cyclic or noncyclic organic carbonates.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (I) and (II)

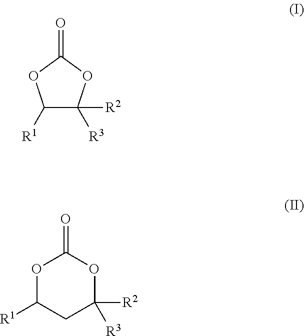

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (III).

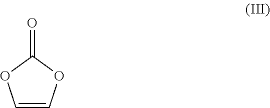

The solvent(s) is (are) preferably used in what is known as the anhydrous state, i.e. with a water content in the range from 1 ppm to 0.1% by weight, determinable, for example, by Karl Fischer titration.

In one embodiment of the present invention, inventive electrochemical cells comprise one or more conductive salts, preference being given to lithium salts. Examples of suitable lithium salts are LiPF₆, LiBF₄, LiClO₄, LiAsF₆, LiCF₃SO₃, LiC(CnF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,

m=2 when X is selected from nitrogen and phosphorus, and

m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF6 and LiN(CF₃SO₂)₂.

In one embodiment of the present invention, inventive rechargeable electrical cells comprise one or more separators by which the electrodes are mechanically separated. Suitable separators are polymer films, especially porous polymer films, which are unreactive toward metallic lithium and toward lithium sulfides and lithium polysulfides. Particularly suitable materials for separators are polyolefins, especially porous polyethylene in film form and porous polypropylene in film form.

Separators made from polyolefin, especially made from polyethylene or polypropylene, may have a porosity in the range from 35 to 45%. Suitable pore diameters are, for example, in the range from 30 to 500 nm.

In another embodiment of the present invention, the separators selected may be separators made from PET nonwovens filled with inorganic particles. Such separators may have a porosity in the range from 40 to 55%. Suitable pore diameters are, for example, in the range from 80 to 750 nm.

Inventive rechargeable electrical cells are notable for particularly high capacitances, improved mechanical stability, high performance even after repeated charging, improved charging and discharging rates, and/or significantly delayed cell death. Shuttling can be suppressed very efficiently. Inventive electrical cells are very suitable for use in automobiles, electric bicycles, aircraft, ships or stationary energy stores. Such uses form a further part of the subject matter of the present invention.

The present invention further provides a process for operating automobiles, electric bicycles, aircraft, ships or stationary energy stores using at least one inventive rechargeable electrical cell.

The invention is explained by the following examples although these do not limit the invention.

Figures in % relate to percent by weight, unless explicitly stated otherwise.

I. Production of Inventive Electrodes

I.1 Production of Electrode Electr.1

Activated Carbon Fiber (ACF) cloth samples (Kynol 2000, American Kynol Inc. USA) were cut in a disc shape of 14 mm in diameter (thickness of 0.6 mm). Elemental Sulfur (99.98% Aldrich) was spread on the bottom of a round stainless steel template of the same diameter and the depth as an electrode corresponding parameters. The carbon discs were overlaid for pre-impregnation with the sulfur and were heated to 140° C. under slightly reduced pressure. Subsequently, the discs were sealed in a stainless steel vessel (SS 316) and were further heated for 10-15 hours at 155° C. The weight of the ACF cloth only was ˜21 mg, and the sulfur load was ˜10 mg. This corresponds to sulfur loading of 33 wt. %.

This gave an inventive electrode electr.1.

II. Production of an Inventive Electrochemical Cell and Test

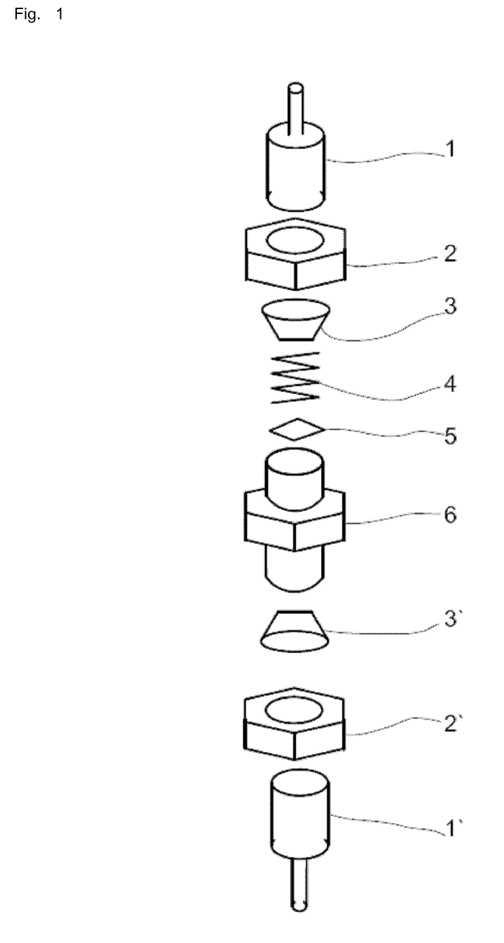

For the electrochemical characterization of the inventive electrodes lectr.1, electrochemical cells were constructed according to FIG. 1. For this purpose, in addition to inventive electrodes, the following were used

anode: Li foil, thickness 1 mm

separator: polypropylene film, thickness 15 μm, porous

cathode according to example I.1

electrolyte: 10% by weight of LiN(SO₂CF₃)₂, 2 wt % of LiNO₃, 44% by weight of 1,3-dioxolane and 44% by weight of 1,2-dimethoxyethane.

FIG. 1 shows the schematic construction of a dismantled electrochemical cell for testing of inventive electrode materials

The annotations in FIG. 1 mean:

1, 1′ die

2, 2′ nut

3, 3′ sealing ring—double in each case, the second, somewhat smaller sealing ring in each case is not shown here

4 spiral spring

5 output conductor made from nickel

6 housing

The electrodes were assembled in a two-electrode configuration with standard coin-type cells (2325, NRC, Canada). The cathodes were impregnated with electrolyte under vacuum and 60 μL of electrolyte was additionally added.

Inventive electrochemical cell EZ.1 (based on inventive electrode electr.1) was obtained.

During the discharge at current density of 650 μA cm² (or 100 mA g⁻¹ sulfur), the cell potential declined to 2.3 to 2.4 volts (1st plateau) and then to 2.0 to 2.1 volts (2nd plateau). The cells were discharged down to 1.7 V and then charged. During the charging operation, the cell potential rose to 2.2 volts, and the cell was charged until attainment of 2.48 volts. Then the discharging operation began again. The current for the first five initial cycles was 1 mA (current density of 650 μA cm⁻² or 100 mA g⁻¹ sulfur) and later was increased to 1.5 mA (current density of 975 μA cm⁻² or 150 mA g⁻¹ sulfur). The inventive electrochemical cells produced attained more than 40 cycles with only a very small loss of capacity.

Coin cells were tested in galvanostatic mode at various currents at 30° C.

1. An electrode material, comprising
activated carbon fibers which are impregnated with
elemental sulfur.

2. The electrode material according to claim 1, wherein the activated carbon fibers before impregnation with sulfur are in the form of a woven fabric, felt, nonwoven, paper or mat.

3. The electrode material according to claim 1, wherein the material is free of a binder.

4. The electrode material according to claim 1, wherein the activated carbon fibers before impregnation with sulfur have a specific surface area of from 500 to 4000 m²/g.

5. The electrode material according to claim 1, wherein the activated carbon fibers before impregnation with sulfur have a pore volume of from 0.2 to 1.5 cm³/g.

6. The electrode material according to claim 1, wherein the activated carbon fibers before impregnation with sulfur have a tensile strength of from 5 to 50 kg/mm².

7. The electrode material according to claim 1, wherein the activated carbon fibers before impregnation with sulfur have a carbon content of from 95 to 100%.

8. The electrode material according to claim 1, wherein the activated carbon fibers are obtained by thermal treatment of fibers comprising a crosslinked phenol-formaldehyde resin, wherein the thermal treatment takes place at temperature in the range from 700 to 2500° C.

9. A rechargeable electrical cell comprising an electrode obtained from or with an electrode material according to claim 1.

10. The rechargeable electrical cell according to claim 9, which further comprises an electrode comprising metallic lithium.

11. The rechargeable electrical cell according to claim 9, which comprises a liquid electrolyte comprising a conductive salt comprising lithium.

12. The rechargeable electrical cell according to claim 1, which comprises at least one nonaqueous solvent selected from the group consisting of polymers, cyclic or noncyclic ethers, noncyclic or cyclic acetals and cyclic or noncyclic organic carbonates.

13. A process for producing an electrode material according to claim 1, comprising heating
activated carbon fibers and
elemental sulfur
with one another at a temperature of from 100 to 300° C. in a closed vessel.

14. The of a rechargeable electrical cell according to claim 9, wherein the cell is suitable for automobiles, electric bicycles, aircraft, ships or stationary energy stores.
